(19) United States
(12) Patent Application Publication
(10) Pub. No.: US 2023/0368699 A1
(43) Pub. Date: Nov. 16, 2023

(54) INFORMATION PROCESSING METHOD AND APPARATUS, READABLE MEDIUM, ELECTRONIC DEVICE, AND PROGRAM PRODUCT

(71) Applicant: Tencent Technology (Shenzhen) Company Limited, Shenzhen (CN)

(72) Inventor: Shili XU, Shenzhen (CN)

(73) Assignee: Tencent Technology (Shenzhen) Company Limited, Shenzhen (CN)

(21) Appl. No.: 18/225,954

(22) Filed: Jul. 25, 2023

Related U.S. Application Data
(63) Continuation of application No. PCT/CN2022/137795, filed on Dec. 9, 2022.

(30) Foreign Application Priority Data
Apr. 25, 2022 (CN) 202210441665.0

(51) Int. Cl. G09B 21/00; G06F 3/01; G06F 40/205; G06F 40/197; G06F 40/274

(52) U.S. Cl. CPC G09B 21/003; G06F 3/016; G06F 40/205; G06F 40/197; G06F 40/274

(57) ABSTRACT

Some aspects of the disclosure provide a method for information processing. The method includes receiving an output content for a screen display of a terminal device. The output content includes at least a first character. The method includes converting the output content to one or more vibration codes, the first character in the output content is converted into a first vibration code of the one or more vibration codes. The method further includes generating, according to the one or more vibration codes and a set of preset vibration parameters, a device vibration instruction corresponding to the output content, and controlling, according to the device vibration instruction, the terminal device to generate at least a first vibration with a first vibration frequency and a second vibration with a second vibration frequency that is different from the first vibration frequency. Apparatus and non-transitory computer-readable storage medium counterpart embodiments are also contemplated.

### RELATED APPLICATIONS

The present application is a continuation of International Application No. PCT/CN2022/137795, entitled “INFORMATION PROCESSING METHOD AND APPARATUS, READABLE MEDIUM, ELECTRONIC DEVICE, AND PROGRAM PRODUCT” and filed on Dec. 9, 2022, which claims priority to Chinese Patent Application No. 202210441665.0, entitled “INFORMATION PROCESSING METHOD AND APPARATUS, READABLE MEDIUM, ELECTRONIC DEVICE, AND PROGRAM PRODUCT” and filed on Apr. 25, 2022. The entire disclosures of the prior applications are hereby incorporated by reference.

### FIELD OF THE TECHNOLOGY

This disclosure relates to the technical field of artificial intelligence, including an information processing method and apparatus, a readable medium, an electronic device, and a program product.

### BACKGROUND OF THE DISCLOSURE

Watching and listening are basic ways to obtain external information. However, in some cases, when the visual sense and auditory sense are affected, the difficulty of obtaining information increases. For example, objects with visual or auditory impairments are often unable to obtain information visually. Although information can be obtained through auditory perception and Braille, the efficiency and accuracy of obtaining information would significantly decrease when the objects with visual or auditory impairments are in special environments with dim light, loud noise, and the like. Therefore, there is an urgent need for a new way to assist users in obtaining external information.

### SUMMARY

Embodiments of this disclosure provide an information processing method and apparatus, a non-transitory computer-readable storage medium, an electronic device, and a program product.

Some aspects of the disclosure provide a method for information processing. The method includes receiving an output content for a screen display of a terminal device. The output content includes at least a first character. The method includes converting the output content to one or more vibration codes, the first character in the output content is converted into a first vibration code of the one or more vibration codes. The method further includes generating, according to the one or more vibration codes and a set of preset vibration parameters, a device vibration instruction corresponding to the output content, and controlling, according to the device vibration instruction, the terminal device to generate at least a first vibration with a first vibration frequency and a second vibration with a second vibration frequency that is different from the first vibration frequency.

Some aspects of the disclosure provide an apparatus for information processing. The apparatus includes processing circuitry configured to receive an output content for a screen display of a terminal device, the output content includes at least a first character. The processing circuitry is configured to convert the output content to one or more vibration codes, the first character in the output content is converted into a first vibration code of the one or more vibration codes. The processing circuitry is further configured to generate, according to the one or more vibration codes and a set of preset vibration parameters, a device vibration instruction corresponding to the output content, and control, according to the device vibration instruction, the terminal device to generate at least a first vibration with a first vibration frequency and a second vibration with a second vibration frequency that is different from the first vibration frequency.

Some aspects of the disclosure also provide a non-transitory computer-readable storage medium storing instructions which when executed by at least one processor in a terminal device cause the at least one processor to perform the method for information processing.

It is to be understood that the foregoing general descriptions and the following detailed descriptions are for illustration and explanation purposes and are not intended to limit this disclosure.

### BRIEF DESCRIPTION OF THE DRAWINGS

It is noted that the accompanying drawings here are incorporated into the specification and form a part of the specification, demonstrating exemplary embodiments of this disclosure and used together with the specification to explain the principles of this disclosure.

FIG. 1 schematically shows a block diagram of an exemplary system architecture applying the technical solutions of this disclosure.

FIG. 2A schematically shows a schematic diagram of an application scenario according to an embodiment of this disclosure.

FIG. 2B schematically shows a schematic diagram of another application scenario according to an embodiment of this disclosure.

FIG. 3 schematically shows a flowchart of an information processing method provided according to one embodiment of this disclosure.

FIG. 4 schematically shows a flowchart of generating vibration code information provided according to one embodiment of this disclosure.

FIG. 5 schematically shows a schematic diagram of a Braille dot matrix provided according to one embodiment of this disclosure.

FIG. 6A schematically shows a schematic diagram of a Braille dot matrix of a letter A provided according to one embodiment of this disclosure.

FIG. 6B schematically shows a schematic diagram of a Braille dot matrix of a letter B provided according to one embodiment of this disclosure.

FIG. 7 schematically shows a flowchart of an information processing method provided according to one embodiment of this disclosure.

FIG. 8 schematically shows a structural block diagram of an information processing apparatus provided by an embodiment of this disclosure.

FIG. 9 schematically shows a structural block diagram of a computer system applicable for implementing an electronic device according to an embodiment of this disclosure.

### DESCRIPTION OF EMBODIMENTS

Exemplary implementations will now be described with reference to the accompanying drawings. However, the examples of implementations may be implemented in various forms. Other implementations are within the scope of the present disclosure.

In addition, the described features, structures or characteristics may be combined in one or more embodiments in any appropriate manner. In the following descriptions, details are provided to give a more comprehensive understanding of the embodiments of this disclosure. However, the technical solutions in this disclosure may be implemented without one or more of the particular details, or another method, unit, apparatus, or step may be used.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

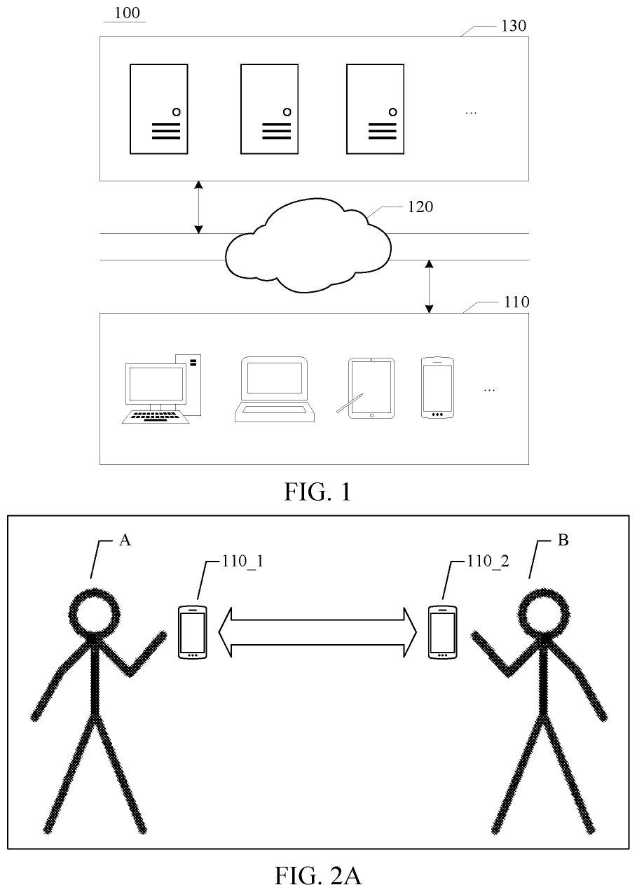

FIG. 1 schematically shows a block diagram of an exemplary system architecture applying the technical solutions of this disclosure.

As shown in FIG. 1, the system architecture 100 may include a terminal device 110, a network 120, and a server 130. The terminal device 110 may include a smartphone, a tablet computer, a laptop computer, an intelligent voice interaction device, a smart home appliance, a vehicle-mounted terminal, and the like. The server 130 may be an independent physical server, a server cluster composed of a plurality of physical servers, or a distributed system, or may be a cloud server that provides cloud computing services. The network 120 may be a communication medium of various connection types that can provide communication links between the terminal device 110 and the server 130, such as a wired or wireless communication link.

According to implementation needs, the system architecture in this embodiment of this disclosure may have any number of terminal devices, networks, and servers. For example, the server 130 may be a server group composed of a plurality of server devices. In addition, the technical solution provided in this embodiment of this disclosure can be applied to the terminal device 110, or the server 130, or jointly implemented by the terminal device 110 and the server 130. This disclosure does not make special restrictions on this.

For example, an information processing method provided by this embodiment of this disclosure is performed by the terminal device 110. The terminal device 110 obtains a screen output content, the screen output content including a plurality of characters. Then, the terminal device 110 converts each character in the screen output content into a vibration code to obtain vibration code information corresponding to the screen output content. Next, the terminal device 110 generates, according to the vibration code information and a preset vibration parameter, a device vibration instruction corresponding to the screen output content. Finally, the terminal device 110 generates vibration according to the device vibration instruction. In this way, the terminal device 110 provides a new information presentation manner. That is, the screen output content is shown in a vibration manner. The screen output content can also be efficiently and accurately obtained in a dim and noisy special environment.

In one embodiment of this disclosure, the information processing method provided by this embodiment of this disclosure is jointly performed by the server 130 and the terminal device 110. The terminal device 110 sends own screen output content to the server 130. The server 130 converts each character in the screen output content into a vibration code to obtain vibration code information corresponding to the screen output content, and generates a device vibration instruction corresponding to the screen output content in combination with a preset vibration parameter. Then, the server 130 sends the device vibration instruction to the terminal device 110, so that the terminal device 110 generates vibration according to the device vibration instruction.

In one embodiment of this disclosure, a user of the terminal device 110 is an object with vision disorder. For example, the vision disorder object reads a text with the terminal device 110. The terminal device 110 takes text information displayed on a screen as screen output content, and then converts each character in the text information into a vibration code to obtain vibration code information corresponding to the text information. Each character can be first converted into a corresponding Braille character dot matrix, and the Braille character dot matrix is then converted into a vibration code. Next, the terminal device 110 generates a device vibration instruction according to the vibration code information of the text information and a preset vibration parameter. The preset vibration parameter includes a vibration frequency, a vibration duration, and the like. A Braille character dot matrix is composed of six points. The Braille character dot matrix corresponding to one character may include raised points and non-raised points. The raised points and the non-raised points can be distinguished by the vibration codes by setting different vibration frequencies for the raised points and the non-raised points. The vibration duration is used for expressing a duration corresponding to the vibration of each point. The vibration duration can also be shortened or prolonged by a vibration speed. After the device vibration instruction is generated, the terminal device 110 generates vibration according to the device vibration instruction. The vision disorder object can touch the terminal device 110 to sense the text information shown by the terminal device 110. For example, the text information contains a letter A. In the Braille character dot matrix of the letter A, point 1 is a raised point, and the other five points are non-raised points. Assuming that high-frequency vibration represents a raised point and low-frequency vibration represents a non-raised point, the vision disorder object can know that the currently identified text information is the letter A after sensing that the terminal device 110 has generated one high-frequency vibration and five continuous low-frequency vibrations.

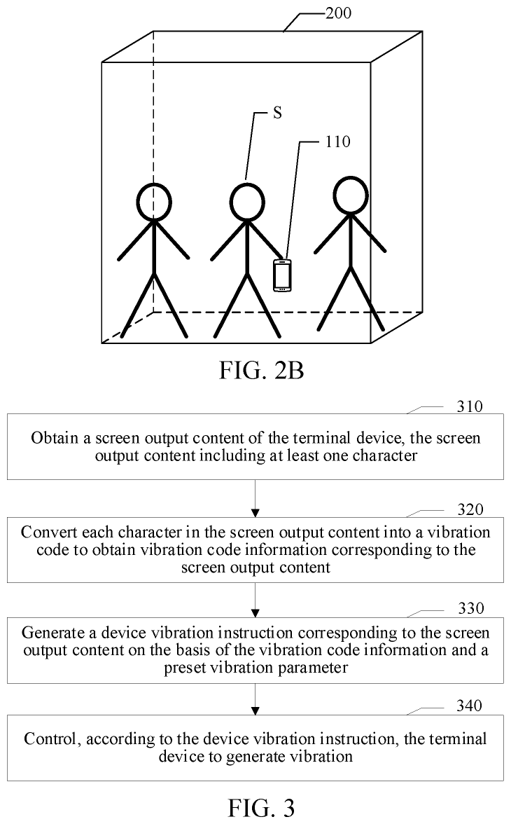

In one embodiment of this disclosure, many users take recreational activities using the terminal device 110 to implement the information processing method provided by this embodiment of this disclosure. For example, FIG. 2A shows a schematic diagram of an application scenario according to an embodiment of this disclosure. As shown in FIG. 2A, a user A types a piece of information on a terminal device 110_1. This piece of information may be any one of or a combination of more of a phrase, a sentence, a digit, a symbol, and the like. The terminal device 110_1 sends the information to a terminal device 110_2. The terminal device 110_2 takes the information as a screen output content; then converts each character in the information into a vibration code to obtain vibration code information of the information; and combines the vibration code information of the information with a preset vibration parameter to generate a device vibration instruction. The terminal device 110_2 generates vibration according to the device vibration instruction. A user B senses the vibration of the terminal device 110_2 to guess what the user A intends to express. The user B may type the sensed information to the terminal device 110_2. The terminal device 110_2 compares the information sensed by the user B with the information received by the terminal device 110_1 to judge whether the information sensed by the user B is correct. Or, the user B types the sensed information to the terminal device 110_2. The terminal device 110_2 sends the information sensed by the user B to the terminal device 110_1. The terminal device 110_1 displays the information to the user A. The user judges whether the information sensed by the user B is correct.

For example, FIG. 2B shows a schematic diagram of an application scenario according to an embodiment of this disclosure. As shown in FIG. 2B, in a closed space 200, it is inconvenient for a user S to obtain information through vision perception and auditory perception. The user S can enable a mode of a terminal device 110 by a gesture, a button, a voice, and the like, to perform the information processing method provided by the embodiments of this disclosure. For example, the user S presses a specific button set on the terminal device 110 to enable a vibration mode of the terminal device 110, to implement the information processing method provided by the embodiments of this disclosure. In this mode, the terminal device 110 obtains a screen output content, then converts each character contained in the screen output content into a vibration code to obtain vibration code information, generates a device vibration instruction according to the vibration code information and a preset vibration parameter, and finally generates vibration according to the device vibration instruction. In this way, the user S may also obtain information through the terminal device 110 in the closed space 200.

The information processing method provided by this disclosure is described in detail below in combination with specific implementations.

FIG. 3 schematically shows a flowchart of an information processing method provided according to one embodiment of this disclosure. The information processing method is performed by an electronic device, and may be performed by a terminal device. As shown in FIG. 3, the information processing method includes step 310 to step 340, for example as follows:

In step 310, a screen output content of the terminal device is obtained, the screen output content includes at least one character.

In some examples, the screen output content of the terminal device refers to content information displayed on a display screen of the terminal device. Generally, the screen output content is text information which is composed of one or more characters and may be one of or a combination of more of letters, Chinese characters, digits, symbols, and the like.

In one embodiment of this disclosure, screen display information of the terminal device may be obtained as the screen output content according to an information processing mode of the terminal device. The screen output content is determined on the basis of the information processing mode of the terminal device. When the terminal device is in different information processing modes, corresponding screen output contents can be accurately obtained, so that the accuracy of obtaining the screen output content can be ensured.

In one embodiment, the information processing mode of the terminal device includes an operation processing mode and an information display mode. The obtaining screen display information of the terminal device as the screen output content according to an information processing mode of the terminal device includes: taking, in a case that the information processing mode of the terminal device is an operation processing mode, text information associated with an operation component selected by the terminal device as the screen output content; and taking, in a case that the information processing mode of the terminal device is an information display mode, text information displayed on a screen of the terminal device as the screen output content.

The operation processing mode refers to a mode in which a user can operate the terminal device. In the operation processing mode, the screen display information of the terminal device is usually text information associated with an operation component selected by the user, namely, a prompt content of the operation component. For example, the user selects a certain button on the display screen. Prompt information of the button is used as the screen output content, for example, “Confirm”, “Back”, “Operation complete”, and the like. The text information associated with the operation component may also be a paragraph selected in the display screen.

The information display mode refers to a mode in which a user browses information instead of operation. At this time, the text information displayed on the screen is the screen output content. For example, when the user reads a novel, a content of the novel displayed on the screen is the screen output content. In this embodiment, when the terminal device is in the operation processing mode, the text information associated with the operation component selected by the terminal device is used as the screen output content. When the terminal device is in the information display model, the text information displayed on the screen of the terminal device is used as the screen output content. Therefore, the corresponding screen output content can be accurately obtained, and the accuracy of obtaining the screen output content can be ensured.

In one embodiment of this disclosure, whether to obtain screen output content may be judged according to information of an environment where the terminal device is located. This process includes: obtaining environmental noise of an environment where the terminal device is located, and determining whether the terminal device is in a vibration mode; and obtaining the screen output content of the terminal device in a case that the environmental noise is greater than a preset noise threshold and that the terminal device is in the vibration mode.

In some examples, the screen output content is obtained in a case that the environment where the terminal device is located is special. The information of the environment where the terminal device is located may be judged according to the environmental noise. When the environmental noise is greater than the preset noise threshold, it indicates that the environment where the terminal device is located is special, the screen output content may be obtained. In the technical solution of this disclosure, the terminal device needs to be controlled to generate vibration, so that whether the terminal device is in the vibration mode can be further judged. When the environmental noise exceeds the preset noise threshold and the terminal device is in vibration mode, the screen output content of the terminal device is obtained, so as to convert the screen output content into vibration information in the subsequent steps. If the terminal device is not in the vibration mode, even if the screen output content is converted into the vibration information, the terminal device cannot be controlled to generate vibration, so there is no need to obtain the screen output content in this case. In this embodiment, whether to trigger the obtaining screen output content of the terminal device is determined according to the environmental noise of the environment where the terminal device is located and according to whether the terminal device is in the vibration mode, so that information processing can be performed on the basis of the screen output content under a scenario condition of processing information by vibration. It can be ensured that the information processing method can be triggered in an appropriate scenario, so as to ensure the information obtaining efficiency and accuracy in a scenario of processing information by vibration. The applicability of information obtaining to environments is also improved.

In one embodiment of this disclosure, the obtaining the screen output content of the terminal device includes: obtaining environmental noise and environmental light intensity of an environment where the terminal device is located; and obtaining the screen output content of the terminal device in a case that the environmental noise is greater than a preset noise threshold and that the environmental light intensity is less than a preset threshold.

In some examples, the information of the environment where the terminal device is located may be judged by combining the environmental noise and environmental light. For example, when the environmental noise is greater than the preset noise threshold and the environmental light intensity is less than the preset threshold, it indicates that the terminal device is in a dim and noisy environment. In this case, the vibration mode of the terminal device may also be automatically enabled, thus obtaining the screen output content. In this embodiment, whether to trigger the obtaining screen output content of the terminal device is determined according to the environmental noise of the environment where the terminal device is located and the environmental light intensity, so that information processing can be performed on the basis of the screen output content under a scenario condition of processing information by vibration. It can be ensured that the information processing method can be triggered in an appropriate scenario, so as to ensure the information obtaining efficiency and accuracy in a scenario of processing information by vibration. The applicability of information obtaining to environments is also improved.

In one embodiment of this disclosure, the step of determining the information of the environment of the terminal device and the step of determining whether the terminal device is in vibration mode can be executed concurrently or in sequence. This disclosure does not limit the execution order of the various steps.

In step 320, each character in the screen output content is converted into a vibration code to obtain vibration code information corresponding to the screen output content.

In some examples, the vibration code information describes the screen output content using the vibration codes. A vibration code of a character indicates a form of vibration for representing the character. A comparison table for the characters and their vibration codes may be preset. The table is looked up to obtain the vibration codes of the various character in the screen output content. The vibration codes of the various characters are arranged in an order in which they are arranged in the screen output content, to obtain the screen output content.

In one embodiment of this disclosure, the conversion of the characters into the vibration codes relies on coding policy information, so before the converting each character into a vibration code, the method further includes: obtaining coding policy information, for example as follows: obtaining a code description file; and parsing the code description file to obtain coding policy information, the coding policy information being used for converting a character into a vibration code, and the coding policy information including a code format and a preset code parameter. The code format is used for expressing a code structure of the vibration code, and the preset code parameter includes at least one of a vibration frequency and a single vibration duration.

In some examples, the code description file may be pre-stored in the terminal device or may be obtained from a server side by the terminal device. The terminal device parses the code description file to obtain the coding policy information. The coding policy information includes the code format and the preset code parameter. The code format represents the code structure of the vibration code, that is, how a character is converted into a vibration code, which is the main content of the code description file. The preset code parameter includes at least one of the vibration frequency and the single vibration duration. The single vibration duration refers to a duration of a vibration, for example, for a vibration code of a letter A: vibration at frequency 1| vibration at frequency 2| vibration at frequency 2| interval vibration| vibration at frequency 2| vibration at frequency 2| vibration at frequency 2| end code. Vibration at frequency 1 represents vibration at a first frequency, and vibration at frequency 2 represents vibration at a second frequency. The vibration at frequency 1, the vibration at frequency 2, the interval vibration, and the end code all represent one vibration. A vibration duration of each vibration may be the same or different. Assuming that the vibration durations of the various vibrations are equal, for example, 60 ms, the letter A will vibrate eight times for 480 ms. A Chinese character is composed of two characters, taking about 960 ms.

In one embodiment of this disclosure, the preset vibration parameter may also include a vibration intensity, a coding policy version, a vibration speed, and the like. The coding policy version is a version number of the coding policy information, such as a first version and a second version. The vibration speed refers to a play speed of vibration, such as 0.5 time of the speed, 1 time of the speed, and 2 times of the speed. In this embodiment, the code format and the preset code parameter are determined according to the coding policy information obtained by parsing. The characters are converted into the corresponding vibration codes by using the code format and the preset code parameter, so that the satisfactory vibration codes can be quickly obtained, and the processing efficiency of converting the characters into the vibration codes is ensured.

In one embodiment of this disclosure, the terminal device parses the code description file to obtain the coding policy version. The following steps are further included at this time: obtaining a coding policy version currently configured by the terminal device, and detecting whether the coding policy version is a specified version; obtaining, in a case that the coding policy version is the specified version, coding policy information corresponding to be the specified version; and updating the coding policy version to be the specified version in a case that the coding policy version is not the specified version, and obtaining coding policy information of the specified version, the coding policy information of the specified version being used for converting each character in the screen output content into the vibration code.

In some examples, the coding policy version obtained by parsing is the coding policy version currently configured by the terminal device. The terminal device compares the coding policy version with the specified version. The specified version is usually a version corresponding to specified coding policy information, such as the latest version. If the coding policy version is the specified version, the terminal device obtains the coding policy information corresponding to be the specified version, and then converts each character in the screen output content into the vibration code on the basis of the coding policy information of the specified version. If the coding policy version is not the specified version, the terminal device needs to update the coding policy version to be the specified version, to obtain the coding policy information corresponding to be the specified version. In this embodiment, by detecting whether the coding policy version is the specified version, it is ensured that each character in the screen output content can be converted into the vibration code on the basis of the coding policy information of the specified version, which can ensure the accuracy of converting the character into the vibration code.

In one embodiment, the obtaining a coding policy version currently configured by the terminal device includes: obtaining a code description file for the terminal device; and parsing the code description file to obtain the coding policy version currently configured by the terminal device.

The coding policy version is a version number of the coding policy information, such as a first version and a second version. The coding policy version may be obtained by parsing the code description file of the terminal device. In some examples, a terminal may obtain the code description file for the terminal device, and parse the code description file to obtain the coding policy version currently configured by the terminal device. The code description file of the terminal device is parsed to determine the coding policy version currently configured by the terminal device, so that it is beneficial to convert each character in the screen output content into the vibration code through the coding policy information of the coding policy version, which can ensure the accuracy of converting the character into the vibration code.

In step 330, according to the vibration code information and a preset vibration parameter, a device vibration instruction corresponding to the screen output content is generated.

In some examples, the terminal device combines the vibration code information of the screen output content with the preset vibration parameter to generate the device vibration instruction. The device vibration instruction refers to an instruction that can be identified and executed by the terminal device. The preset vibration parameter includes a preset vibration duration, a vibration intensity, a vibration speed, and the like. The preset vibration duration is equivalent to the single vibration duration mentioned above.

In one embodiment of this disclosure, the preset vibration parameter includes a vibration speed. The process of generating the device vibration instruction includes: adjusting, according to the vibration speed, a preset vibration duration contained in the vibration code information, the preset vibration duration representing a duration of one vibration; and generating the device vibration instruction according to an adjusted vibration duration in the vibration code information.

In some examples, the vibration speed is used for adjusting the preset vibration duration. Generally, a default vibration speed is 1, which may also be adjusted by other means during use. For example, the preset vibration duration is 60 ms. If the vibration speed is 1, the preset vibration duration is kept being unchanged at 60 ms. If the vibration speed is 2, the preset vibration duration is changed from 60 ms to 30 ms. If the vibration speed is 0.5, the preset vibration duration is changed from 60 ms to 120 ms. A device vibration instruction that is obtained after the vibration duration is adjusted is the device vibration instruction that is finally executed by the terminal device. In this embodiment, the preset vibration duration in the vibration code information can be adjusted by using the vibration speed in the preset vibration parameter, so as to flexibly adjust the vibration duration and adapt to various application scenarios.

In step 340, according to the device vibration instruction, the terminal device is controlled to generate vibration.

In some examples, the controlling the device to generate vibration according to the device vibration instruction is to represent the screen output content in the form of vibration. The external world can obtain the information contained in the screen output content through tactile perception.

In the technical solution provided in the embodiment of this disclosure, the screen output content of the terminal device is obtained; each character in the screen output content is converted into the vibration code to obtain the vibration code information corresponding to the screen output content; the device vibration instruction corresponding to the screen output content is then generated on the basis of the vibration code information and the preset vibration parameter; and finally, the terminal device is controlled, according to the device vibration instruction, to generate the vibration. Therefore, the information contained in the screen output content is expressed in the form of vibration, allowing the external world to obtain the information through the tactile perception. This ensures that the information obtaining is not limited in special environments such as dim and noisy environments, which improves the information obtaining efficiency and accuracy in the special environments and also improves the adaptability of information obtaining to the environments.

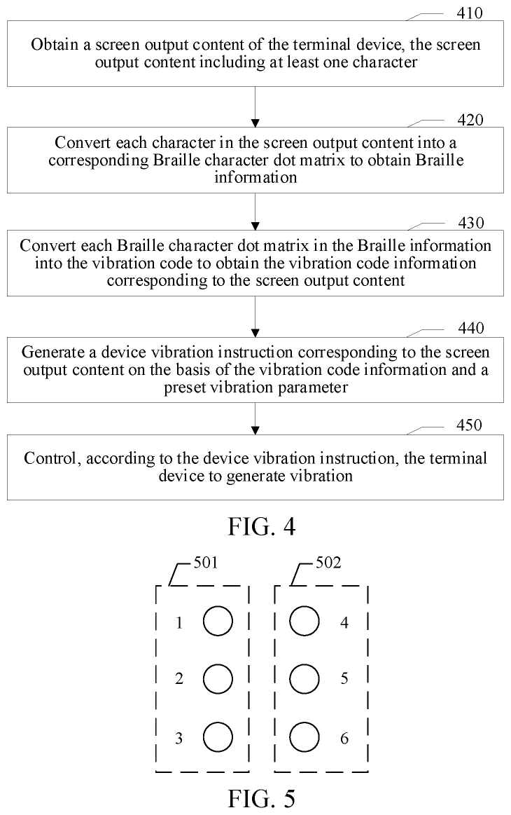

FIG. 4 schematically shows a flowchart of an information processing method provided according to one embodiment of this disclosure. As shown in FIG. 4, the method includes step 410 to step 450, for example as follows:

In step 410, a screen output content of the terminal device is obtained, the screen output content includes at least one character.

In some examples, the obtaining of the screen output content may refer to the related description in foregoing step 310.

In step 420, each character in the screen output content is converted into a corresponding Braille character dot matrix to obtain Braille information.

In some examples, firstly, the screen output content is converted into the Braille information, and vibration code information is then generated on the basis of the Braille information. During the conversion of the screen output content into the Braille information, each character of the screen output content is converted one by one.

In this embodiment of this disclosure, as shown in FIG. 5, one Braille character is represented by a dot matrix with a 2*6 size. The dot matrix is divided into a left column and a right column. The left column is actually a dot matrix with a 1*3 size, referred to as a left dot matrix 501, and serial numbers of the various points are 1, 2, and 3 from top to bottom. The right column is actually also a dot matrix with a 1*3 size, referred to as a right dot matrix 502, and serial numbers of the various points are 4, 5, and 6 from top to bottom. Different characters are represented by setting points at different positions to be raised points.

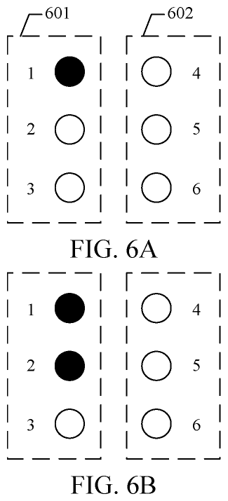

The dot matrix information after conversion of one character is referred to as a Braille character dot matrix in this disclosure. The conversion of a character into a Braille character dot matrix may be achieved according to a Braille table. For example, the Braille character dot matrix corresponding to the letter A is shown in FIG. 6A. The black point represents a raised point. Point 1 in FIG. 6A is a raised point, and the remaining points are non-raised points.

In one embodiment of this disclosure, when the screen output content is a Chinese character, the Chinese character is first converted into a corresponding pinyin, and then the pinyin is converted into a Braille character dot matrix. For a Chinese character, its pinyin is generally composed of an initial consonant and a vowel, both of which are separate characters. That is, a Chinese character is composed of two characters, which correspond to two Braille character dot matrices. For example, for a Chinese character “ [symbol] ”, its pinyin is “hao”, the initial consonant “h” is converted into a Braille character dot matrix, and the vowel “ao” is converted into another Braille character dot matrix.

In step 430, each Braille character dot matrix in the Braille information is converted into the vibration code (e.g., sub vibration code) to obtain the vibration code information corresponding to the screen output content.

In some examples, after the Braille information is obtained, the terminal device converts each Braille character dot matrix into the vibration code to obtain the vibration code information of the screen output content. During the converting the Braille character dot matrix into the vibration code, the terminal device may also obtain the vibration code by presetting a comparison table between the Braille character dot matrices and the vibration codes and looking up the table.

In one embodiment of this disclosure, the terminal device converts the Braille character dot matrices into the vibration codes by: generating, according to whether each point in the left dot matrix is a raised point (also referred to as raised status), a vibration code (e.g., a first sub vibration code) of the left dot matrix contained in each Braille character dot matrix; generating, according to whether each point in the right dot matrix is a raised point, a vibration code (e.g., a second sub vibration code) of the right dot matrix contained in each Braille character dot matrix; and generating the vibration code of each Braille character dot matrix according to the vibration code of the left dot matrix, a preset interval vibration code, the vibration code of the right dot matrix, and a preset end code.

In some examples, in this embodiment of this disclosure, the Braille character dot matrix is divided into two portions distributed on the left and right relatively: a left dot matrix and a right dot matrix. The terminal device converts the two portions into the corresponding vibration codes, and then combines the vibration codes corresponding to the two portions to generate the vibration code corresponding to the Braille character dot matrix. The vibration code of the left or right dot matrix is determined by whether each point in the left or right dot matrix is a raised point. Since the manner of converting the left dot matrix into the vibration code is the same as the manner of converting the right dot matrix into the vibration code, the left dot matrix will be used as an example to illustrate a coding manner of this embodiment of this disclosure.

In one embodiment, the generating, according to whether each point in the left dot matrix is a raised point, a vibration code of the left dot matrix contained in each Braille character dot matrix includes: generating, in a case that the points in the left dot matrix are raised points, vibration codes with a first frequency as vibration codes of the raised points; generating, in a case that the points in the left dot matrix are non-raised points, vibration codes with a second frequency as vibration codes of the non-raised points, the second frequency being different from the first frequency; and arranging the vibration codes of the various points in the left dot matrix in order, and generating the vibration code of the left dot matrix.

In this embodiment of this disclosure, the vibration codes with different frequencies are used to represent the raised and non-raised points in the Braille character dot matrix, for example including the left dot matrix and the right dot matrix, in both of which, the vibration codes with different frequencies can be used to represent the raised points and the non-raised points. In some examples, when the points in the left dot matrix are the raised points, the vibration codes with the first frequency are used as the vibration codes of the raised points. When the points in the left dot matrix are the non-raised points, the vibration codes with the second frequency are used as the vibration codes of the non-raised points. The second frequency is different from the first frequency. For example, the first frequency is a high frequency (such as 300 HZ), and the second frequency is a low frequency (such as 100 HZ). After the vibration code of each point in the left dot matrix is obtained, the vibration codes of the various points are sequenced according to a numbering order of the various point to generate the vibration code of the left dot matrix. For the right dot matrix, the same coding manner as that of the left dot matrix can be used as, in which, the vibration codes with different frequencies are used to represent the raised points and the non-raised points in the right dot matrix. The numbering order of the various point in the Braille character dot matrix is shown in FIG. 5.

In this embodiment, the vibration codes with the first frequency are generated as the vibration codes of the raised points in the left dot matrix, and the vibration codes with the second frequency are generated as the vibration codes of the non-raised points in the left dot matrix, so that a dot matrix content of the left dot matrix can be characterized by the vibration codes with different frequencies, which is conducive to improving the accuracy of expressing information through a dot matrix.

In one embodiment, the generating, according to whether each point in the right dot matrix is a raised point, a vibration code of the right dot matrix contained in each Braille character dot matrix includes: generating, in a case that the points in the right dot matrix are raised points, vibration codes with a first frequency as vibration codes of the raised points; generating, in a case that the points in the right dot matrix are non-raised points, vibration codes with a second frequency as vibration codes of the non-raised points, the second frequency being different from the first frequency; and arranging the vibration codes of the various points in the right dot matrix in order, and generating the vibration code of the right dot matrix.

In this embodiment of this disclosure, the vibration codes with different frequencies are used to represent the raised points and the non-raised points in the right dot matrix. The specific processing may be the same as the processing of the vibration code of the left dot matrix. The vibration codes with the first frequency are generated as the vibration codes of the raised points in the right dot matrix, and the vibration codes with the second frequency are generated as the vibration codes of the non-raised points in the right dot matrix, so that a dot matrix content of the right dot matrix can be characterized by the vibration codes with different frequencies, which is conducive to improving the accuracy of expressing information through a dot matrix.

For example, the Braille character dot matrix of the letter A shown in FIG. 6A is used as an example to illustrate the coding manner of this embodiment of this disclosure. As shown in FIG. 6A, in the left dot matrix 601, the first point (No. 1) is a raised point, corresponding to the vibration code with the first frequency; the second point (No. 2) is a non-raised point, corresponding to the vibration code with the second frequency; and the second point (No. 3) is a non-raised point, corresponding to the vibration code with the second frequency. In the right dot matrix 602, the first point (No. 4) is a non-raised point, corresponding to the vibration code with the second frequency; the second point (No. 5) is a non-raised point, corresponding to the vibration code with the second frequency; and the second point (No. 6) is a non-raised point, corresponding to the vibration code with the second frequency.

If a vibration with the first frequency is denoted as frequency 1 and a vibration with the second frequency is denoted as frequency 2, the vibration code of the left dot matrix 601 may be expressed as: vibration at frequency 1| vibration at frequency 2| vibration at frequency 2, and the vibration code of the right dot matrix 602 may be expressed as: vibration at frequency 2| vibration at frequency 2| vibration at frequency 2. Symbol “|” is only used for distinguishing two vibrations. In an actual coding process, the symbol can be adjusted and selected as required.

In this embodiment of this disclosure, a preset interval vibration code is added between the vibration code of the left dot matrix and the vibration code of the right dot matrix to distinguish the vibration code of the left dot matrix from the vibration code of the right dot matrix. The preset interval vibration code is a vibration code with a set frequency, denoted as interval vibration. Finally, a preset end code is added to indicate the end of the vibration codes of the Braille character dot matrix. The preset end code can be represented by a set symbol or a blank, denoted as an end code. In this embodiment, for the left and right dot matrices in the Braille character dot matrix that are relatively distributed on the left and right, coding of the left and right dot matrices is achieved on the basis of whether the included points are raised points, and the corresponding vibration codes are obtained. Then, the code division is performed by using the preset interval vibration code and the preset end code to generate the vibration code of the Braille character dot matrix, which can achieve accurate coding of the Braille character dot matrix.

Thus, the vibration code of the character A shown in FIG. 6A may be expressed as:

vibration at frequency 1| vibration at frequency 2| vibration at frequency 2| interval vibration| vibration at frequency 2| vibration at frequency 2| vibration at frequency 2| end code.

For example, FIG. 6B shows the Braille character dot matrix corresponding to the letter B. According to the above coding manner, the vibration code of the letter B may be expressed as:

vibration at frequency 1| vibration at frequency 1| vibration at frequency 2| interval vibration| vibration at frequency 2| vibration at frequency 2| vibration at frequency 2| end code.

In this embodiment of this disclosure, the vibration code generation manner of the Braille character dot matrix may also directly generate the vibration codes according to the serial numbers of the various point without distinguishing the left dot matrix and the right dot matrix. It is only necessary to add the preset interval vibration code behind the vibration code of point 3 and add the preset end code behind the vibration code of point 6. Optionally, the preset interval vibration code may not be added.

In one embodiment of this disclosure, the left dot matrix may also be converted into a vibration code by: determining, according to whether each point in the left dot matrix is a raised point, a dot matrix template corresponding to the left dot matrix, the dot matrix template being a dot matrix formed by arranging the raised points and/or the non-raised points in a preset order; and taking a vibration code (e.g., a predetermined vibration code) corresponding to the dot matrix template as the vibration code of the left dot matrix.

In some examples, the terminal device takes the left or right dot matrix as a whole and presets a plurality of dot matrix templates and vibration codes corresponding to the dot matrix templates. During coding, it is only necessary to match the left or right dot matrix to the corresponding dot matrix template to determine the vibration code, instead of necessarily converting each point in the left or right dot matrix into a vibration code, thereby improving the coding efficiency.

In one embodiment, the generating, according to whether each point in the right dot matrix is a raised point, a vibration code of the right dot matrix contained in each Braille character dot matrix includes: determining, according to whether each point in the right dot matrix is a raised point, a dot matrix template corresponding to the right dot matrix, the dot matrix template being a dot matrix formed by arranging the raised points and/or the non-raised points in a preset order; and taking a vibration code corresponding to the dot matrix template as the vibration code of the right dot matrix.

In this embodiment, similar to the processing of the left dot matrix, the right dot matrix can be taken as a whole, a plurality of dot matrix templates and vibration codes corresponding to the dot matrix templates are preset. During coding, it is only necessary to match the right dot matrix to the corresponding dot matrix template to determine the vibration code, instead of necessarily converting each point in the right dot matrix into a vibration code, thereby improving the coding efficiency.

Since the formats of the left and right dot matrices are the same, including three points arranged from top to bottom, the dot matrix template also adopts a dot matrix formed by three points arranged from top to bottom. If points at different positions and in different numbers in the dot matrix are raised points, different dot matrix templates can be obtained.

For the three points arranged from top to bottom, each point may be any one of a raised point and a non-raised point, there are six dot matrix templates. If 1 represents a raised point and 0 represents a non-raised point, there are six dot matrix templates in total, including: 111, 110, 101, 100, 011, 001, and 000. A vibration code is set for each dot matrix template, and the vibration codes corresponding to the various dot matrix templates may be (corresponding to the dot matrix templates listed above one to one): vibration 1, vibration 2, vibration 3, vibration 4, vibration 5, and vibration 6. Vibration parameters can be adjusted to make vibrations corresponding to the various dot matrix templates different. The vibration parameters include one or more of a vibration frequency, a vibration duration, and a vibration intensity.

For example, for the letter A shown in FIG. 6A, the vibration code obtained by matching the dot matrix templates is: vibration 4| interval vibration| vibration 6| end code. For the letter B shown in FIG. 6B, the vibration code obtaining by matching the dot matrix templates is: vibration 2| interval vibration| vibration 6| end code. Therefore, it can be seen that compared to the vibration code of the Braille character dot matrix obtained by converting each point into a vibration code, the vibration code of the Braille character dot matrix obtained on the basis of matching the dot matrix templates is shorter, thereby improving the coding efficiency.

In one embodiment of this disclosure, the vibration code information of the screen output content may also be generated by: performing word segmentation processing on the screen output content to obtain at least one character; generating, in a case that the at least one character includes a first character belonging to a set character library, a vibration code of the first character according to simple coding policy information; and generating, in a case that the at least one character includes a second character not belonging to the set character library, a vibration code of the second character according to set coding policy information (also referred to as regular coding policy), where a length of the vibration code generated according to the simple coding policy information is less than a length of the vibration code generated according to the set coding policy information.

In some examples, first, the terminal device performs the word segmentation processing on the screen output content to obtain the at least one character. The characters may be a single character or characters that form a phrase. Then, the terminal device uses the corresponding coding policy information to generate the vibration codes on the basis of the types of the characters after the word segmentation. The coding policy information refers to a policy of converting the characters into the corresponding vibration codes, for example, the foregoing policy of converting each character into a Braille character dot matrix, and converting each point in the Braille character dot matrix into a vibration code, or a policy of obtaining a vibration code on the basis of matching dot matrix templates.

The types of the characters after the word segmentation are distinguished by setting a character library. If one character is a character in the set character library, the character belongs to a first character. If one character is not a character in the set character library, the character belongs to a second character. The set character library is a character library composed of several pre-selected characters. For example, characters in the set character library include commonly used characters in text information (namely, characters with a higher usage frequency), special characters, and the like.

If a character belongs to the first character, the terminal device uses the simple coding policy information to generate a corresponding vibration code. If a character belongs to the second character, the terminal device uses the set coding policy information to generate a corresponding vibration code. The set coding policy information is a preset conventional coding policy, for example, the foregoing policy of converting the characters into the corresponding vibration codes, for example, the foregoing policy of converting each character into a Braille character dot matrix, and converting each point in the Braille character dot matrix into a vibration code, or a policy of obtaining a vibration code on the basis of matching dot matrix templates. The simple coding policy information is a relatively concise coding policy that involves deleting some repetitive and redundant portions during the generating vibration codes of characters. Therefore, the length of the vibration code generated according to the simple coding policy information is less than a length of the vibration code generated according to the set coding policy information. For example, the vibration code of the letter A is expressed in the simple coding policy information as: vibration at frequency 1| long-term vibration at frequency 2. “Long-term vibration at frequency 2” refers to a long-term vibration with the second frequency. The simple coding policy information of the letter A actually represents the raised points in its Braille character dot matrix through the vibration with the first frequency, and represents the five non-raised points in its Braille character dot matrix through the long-term vibration with the second frequency. It can be seen that the length of the vibration code obtained by the simple coding policy information is significantly less than the length of the vibration code obtained by the set coding policy information, thereby reducing a data processing volume of converting characters into vibration codes and improving the processing efficiency of converting characters into vibration codes.

Optionally, the terminal device may generate the vibration codes of the various characters in the set character library in advance according to the simple coding policy information, form the set character code library, and then search the set character library for the vibration code of the first character. In one embodiment of this disclosure, the terminal device converts the various Braille character dot matrix into the vibration codes according to the coding policy information. The specific process of obtaining the coding policy information can be described in step 320 above.

In step 440, according to the vibration code information and a preset vibration parameter, a device vibration instruction corresponding to the screen output content is generated.

In one embodiment of this disclosure, the process of combining the vibration code information with the preset vibration parameter may be: setting a first preset vibration duration and a first preset vibration intensity for the vibration code of the left dot matrix and the vibration code of the right dot matrix of each Braille character dot matrix; setting a second preset vibration duration and a second preset vibration intensity for the preset interval vibration code of each character dot matrix; setting a third preset vibration duration and a third preset vibration intensity for the preset end code of each character dot matrix; and generating the device vibration instruction on the basis of the vibration code of each character dot matrix after the setting of the vibration duration and the vibration intensity.

In some examples, the terminal device configures the vibration duration and the vibration intensity for the vibration code of each Braille character dot matrix in the vibration code information. For example, the vibration code of the letter A is: vibration at frequency 1| vibration at frequency 2| vibration at frequency 2| interval vibration| vibration at frequency 2| vibration at frequency 2| vibration at frequency 2| end code. “Vibration at frequency 1| vibration at frequency 2| vibration at frequency 2” represent the left dot matrix, and “vibration at frequency 2| vibration at frequency 2| vibration at frequency 2|” represent the right dot matrix. The left dot matrix and the right dot matrix each include three vibrations, and the first preset vibration duration (for example, 60 ms) and the first preset vibration intensity are configured for each vibration respectively. The second preset vibration duration and the second preset vibration intensity are set for the “interval vibration”, and the third preset vibration duration and the third preset vibration intensity are set for the “end code”. The first preset vibration duration, the second preset vibration duration, and the third preset vibration duration may be equal or different. The first preset vibration intensity, the second preset vibration intensity, and the third preset vibration intensity may be equal or different.

In one embodiment of this disclosure, the vibration duration of each vibration may also be adjusted on the basis of a vibration speed. For details, please refer to the relevant description in step 330 above, which will not be described here.

In step 450, according to the device vibration instruction, the terminal device is controlled to generate vibration.

In this embodiment, the screen output content is first converted into the Braille information, and then the device vibration instruction is generated on the basis of the Braille information. This actually presents the Braille information in the form of vibration. A vision disorder person can still obtain the information contained in the screen output content through tactile perception even when it is difficult or inconvenient to obtain information through auditory perception, and the information obtained has relatively high accuracy.

The following will describe an implementation process of the information processing method provided in the embodiments of this disclosure by one specific embodiment.

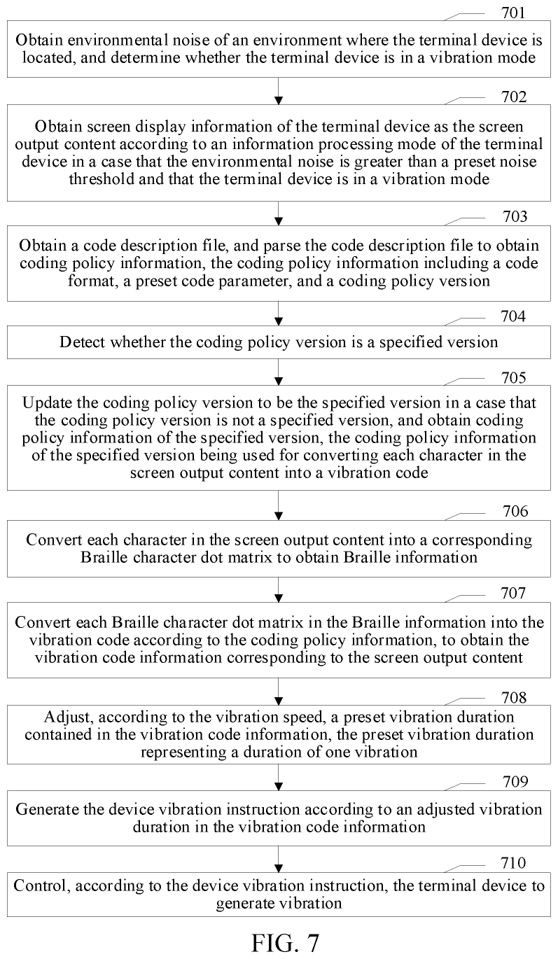

FIG. 7 schematically shows a flowchart of an information processing method provided according to one embodiment of this disclosure. As shown in FIG. 7, the method includes step 701 to step 710, for example as follows:

In step 701, environmental noise of an environment where the terminal device is located is obtained, and whether the terminal device is in a vibration mode is determined.

In step 702, screen display information of the terminal device is obtained as the screen output content according to an information processing mode of the terminal device in a case that the environmental noise is greater than a preset noise threshold and that the terminal device is in a vibration mode.

In some examples, this embodiment of this disclosure performs information processing on the screen output content of the terminal device under the conditions that the environmental noise of the environment where the terminal device is located is greater than the preset noise threshold and that the terminal device is in the vibration mode.

The screen output content is obtained according to the information processing mode of the terminal device. There are two information processing modes: an operation processing mode and an information display mode. In the operation processing mode, text information associated with an operation component selected by the terminal device is the screen output content. In the information display mode, text information displayed on a screen of the terminal device is the screen output content.

In step 703, a code description file is obtained, and the code description file is parsed to obtain coding policy information, the coding policy information includes a code format, a preset code parameter, and a coding policy version.

In some examples, specific contents of the code description file are as shown in Table 1 below.

TABLE 1
Code description file

| Sequence definition | Descriptor | Explanation |
|---|---|---|
| hqh_main_haptics_ver | u(4) | Vibration code protocol |
| | | version number |
| hqh_main_haptics_code | u(4) | Code format |
| hqh_main_haptics_duration | u(8) | Duration of each vibration |
| for (i=0; i<3; i++) | | |
| hqh_main_haptics_code | u(8) | Codes of three points on |
| | | the left in the Braille, |
| | | expressed by an actual |
| | | vibration frequency |
| hqh_main_haptics_interval | u(8) | Vibration frequency of a |
| | | vibration interval between |
| | | the left and right columns |
| for (i=0; i<3; i++) | | |
| hqh_main_haptics_code | u(8) | Codes of three points |
| | | on the right in the Braille, |
| | | expressed by an actual |
| | | vibration frequency |
| hqh_main_haptics_end | u(8) | Vibration identifier for |
| | | the end of a complete piece |
| | | of Braille, describing an |
| | | actual vibration frequency |

In table 1, hqh_main_haptics_ver is the coding policy version, which refers to a version number of the coding policy information currently configured by the terminal device. Hqh_main_haptics_duration is equivalent to the single vibration duration or preset vibration duration mentioned above. The preset code parameters include a duration, frequency, and intensity (not shown in Table 1) of each vibration in Table 1. The “Codes of three points on the left in the Braille” in Table 1 refers to the vibration code of the left dot matrix, and similarly, the “Codes of three points on the right in the Braille” refers to the vibration code of the right dot matrix. Hqh_main_haptics_interval is the preset interval vibration code, and hqh_main_haptics_end is the preset end code.

In step 704, whether the coding policy version is a specified version is detected.

In step 705, when the coding policy version is not the specified version, the coding policy version is updated to be the specified version, and coding policy information of the specified version is obtained. The coding policy information of the specified version is used for converting various characters in the screen output content into vibration codes.

In step 704 to step 705, the coding policy version is detected. When the coding policy version is the specified version, the coding policy information of the specified version is obtained. When the coding policy version is not the specified version, the coding policy version is updated to be the specified version, and the coding policy information is then obtained.

In step 706, each character in the screen output content is converted into a corresponding Braille character dot matrix to obtain Braille information.

In some examples, first, whether there is a Chinese character in the screen output content is detected. If there is a Chinese character, the Chinese character is converted into a Chinese pinyin. The Chinese pinyin and other characters are the converted into Braille character dot matrices according to a Braille table.

In step 707, each Braille character dot matrix in the Braille information is converted into the vibration code according to the coding policy information, to obtain the vibration code information corresponding to the screen output content.

In some examples, the Braille character dot matrix includes a left dot matrix and a right dot matrix. The process of generating the vibration code of the Braille character dot matrix, for example, includes: generating, according to whether each point in the left dot matrix is a raised point, a vibration code of the left dot matrix contained in each Braille character dot matrix; generating, according to whether each point in the right dot matrix is a raised point, a vibration code of the right dot matrix contained in each Braille character dot matrix; and generating the vibration code of the Braille character dot matrix according to the vibration code of the left dot matrix, a preset interval vibration code, the vibration code of the right dot matrix, a preset end code.

In some examples, the raised points in the left or right dot matrix are represented by vibration codes with a first frequency, while the non-raised points in the left or right dot matrix are represented by vibration codes with a second frequency. At the same time, the preset interval vibration code is added between the vibration code of the left dot matrix and the vibration code of the right dot matrix, and the preset end code is added behind the vibration code of the right dot matrix, thus obtaining the vibration code of one Braille character dot matrix. Generally, a vibration code with the first frequency is a high-frequency vibration code, and a vibration code with the second frequency is a low-frequency vibration code. A frequency of the preset interval vibration code is different from the first frequency and the second frequency.

In one embodiment of this disclosure, the vibration code of the Braille character dot matrix can also be generated by means of matching dot matrix templates, or by means of combining simple coding policy information with set coding policy information. For details, please refer to the relevant description in step 430 above, which will not be described here.

In step 708, according to a vibration speed, a preset vibration duration contained in the vibration code information is adjusted, the preset vibration duration represents a duration of one vibration.

In some examples, the vibration speed may be set externally, and the vibration duration in the vibration code information can be shortened or prolonged on the basis of the vibration speed, so that the vibration speed of the terminal device meets an external setting requirement.

In step 709, the device vibration instruction is generated according to an adjusted vibration duration in the vibration code information.

In step 710, according to the device vibration instruction, the terminal device is controlled to generate vibration.

In some examples, the terminal device generates vibration on the basis of the finally generated device vibration instruction, and reflects the screen output content in rhythmic vibrations, which can reduce limitations of a dim and noisy environment and other special environments on the information obtaining efficiency and accuracy.

Although the various steps of the method in this disclosure are described in a specific order in the accompanying drawings, this does not require or imply that the steps are bound to be performed in the specific order, or all the steps shown are bound to be performed to achieve the expected result. Additionally or alternatively, some steps may be omitted, a plurality of steps may be combined into one step for execution, and/or one step may be decomposed into a plurality of steps for execution, and the like.

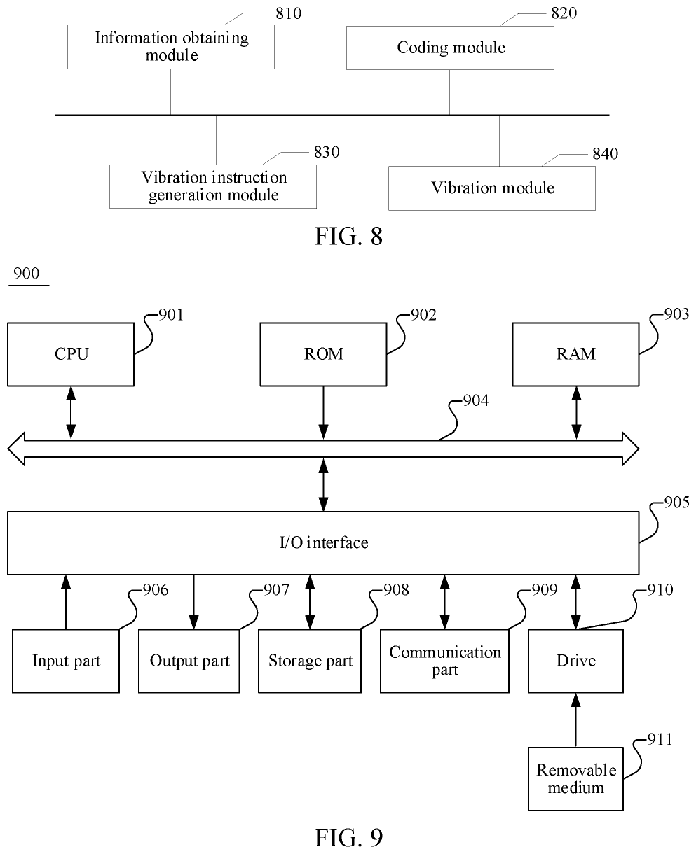

The following describes an apparatus embodiment of this disclosure, and the apparatus embodiment may be used for performing the information processing method in the foregoing embodiment of this disclosure. FIG. 8 schematically shows a structural block diagram of an information processing apparatus provided by an embodiment of this disclosure. As shown in FIG. 8, the information processing apparatus includes:
an information obtaining module 810, configured to obtain a screen output content of the terminal device, the screen output content including at least one character;
a coding module 820, configured to: convert each character in the screen output content into a vibration code to obtain vibration code information corresponding to the screen output content;
a vibration instruction generation module 830, configured to generate, according to the vibration code information and a preset vibration parameter, a device vibration instruction corresponding to the screen output content; and
a vibration module 840, configured to control, according to the device vibration instruction, the terminal device to generate vibration.

In one embodiment of this disclosure, the coding module 820 includes: a Braille conversion unit, configured to convert each character in the screen output content into a corresponding Braille character dot matrix to obtain Braille information; and a Braille coding unit, configured to convert each Braille character dot matrix in the Braille information into the vibration code to obtain the vibration code information corresponding to the screen output content.

In one embodiment of this disclosure, the Braille character dot matrix includes a left dot matrix and a right dot matrix relatively distributed on left and right. The Braille coding unit includes: a left dot matrix coding subunit, configured to generate, according to whether each point in the left dot matrix is a raised point, a vibration code of the left dot matrix contained in each Braille character dot matrix; a right dot matrix coding subunit, configured to generate, according to whether each point in the right dot matrix is a raised point, a vibration code of the right dot matrix contained in each Braille character dot matrix; and a code generation subunit, configured to generate the vibration code of each Braille character dot matrix according to the vibration code of the left dot matrix, a preset interval vibration code, the vibration code of the right dot matrix, and a preset end code.

In one embodiment of this disclosure, the left dot matrix coding subunit is, for example, configured to: generate, in a case that the points in the left dot matrix are raised points, vibration codes with a first frequency as vibration codes of the raised points; generate, in a case that the points in the left dot matrix are non-raised points, vibration codes with a second frequency as vibration codes of the non-raised points, the second frequency being different from the first frequency; and arrange the vibration codes of the various points in the left dot matrix in order, and generate the vibration code of the left dot matrix.

In one embodiment of this disclosure, the left dot matrix coding subunit is for example configured to: determine, according to whether each point in the left dot matrix is a raised point, a dot matrix template corresponding to the left dot matrix, the dot matrix template being a dot matrix formed by arranging the raised points and/or the non-raised points in a preset order; and take a vibration code corresponding to the dot matrix template as the vibration code of the left dot matrix.

In one embodiment, the right dot matrix coding subunit is for example configured to: generate, in a case that the points in the right dot matrix are raised points, vibration codes with a first frequency as vibration codes of the raised points; generate, in a case that the points in the right dot matrix are non-raised points, vibration codes with a second frequency as vibration codes of the non-raised points, the second frequency being different from the first frequency; and arrange the vibration codes of the various points in the right dot matrix in order, and generate the vibration code of the right dot matrix.

In one embodiment, the right dot matrix coding subunit is for example configured to: determine, according to whether each point in the right dot matrix is a raised point, a dot matrix template corresponding to the right dot matrix, the dot matrix template being a dot matrix formed by arranging the raised points and/or the non-raised points in a preset order; and take a vibration code corresponding to the dot matrix template as the vibration code of the right dot matrix.

In one embodiment of this disclosure, the apparatus further includes: a code description file parsing module, configured to obtain a code description file; and parse the code description file to obtain coding policy information, the coding policy information being used for converting a character into a vibration code, and the coding policy information including a code format and a preset code parameter. The code format is used for expressing a code structure of the vibration code, and the preset code parameter includes at least one of a vibration frequency and a single vibration duration.

In one embodiment of this disclosure, the apparatus further includes: a coding policy version detection module, configured to: obtain a coding policy version currently configured by the terminal device, and detect whether the coding policy version is a specified version; and a coding policy obtaining module, configured to: update the coding policy version to be the specified version in a case that the coding policy version is not the specified version, and obtain coding policy information of the specified version, the coding policy information of the specified version being used for converting each character in the screen output content into the vibration code.

In one embodiment of this disclosure, the coding policy version obtaining module is for example configured to: obtain a code description file for the terminal device; and parse the code description file to obtain the coding policy version currently configured by the terminal device.

In one embodiment of this disclosure, the coding module 820 includes: a word segmentation unit, configured to perform word segmentation processing on the screen output content to obtain at least one character; a first coding unit, configured to generate, in a case that the at least one character includes a first character belonging to a set character library, a vibration code of the first character according to simple coding policy information; and a second coding unit, configured to generate, in a case that the at least one character includes a second character not belonging to the set character library, a vibration code of the second character according to set coding policy information, where a length of the vibration code generated according to the simple coding policy information is less than a length of the vibration code generated according to the set coding policy information.

In one embodiment of this disclosure, the preset vibration parameter includes a vibration speed. The vibration instruction generation module 830 is for example configured to: adjust, according to the vibration speed, a preset vibration duration contained in the vibration code information, the preset vibration duration representing a duration of one vibration; and generate the device vibration instruction according to an adjusted vibration duration in the vibration code information.

In one embodiment of this disclosure, the information obtaining module 810 is for example configured to: obtain screen display information of the terminal device as the screen output content according to an information processing mode of the terminal device.

In one embodiment of this disclosure, the information obtaining module 810 includes: a first information obtaining unit, configured to: take, in a case that the information processing mode of the terminal device is an operation processing mode, text information associated with an operation component selected by the terminal device as the screen output content; and a second information obtaining unit, configured to: take, in a case that the information processing mode of the terminal device is an information display mode, text information displayed on a screen of the terminal device as the screen output content.

In one embodiment of this disclosure, the information obtaining module 810 is for example configured to: obtain environmental noise of an environment where the terminal device is located, and determine whether the terminal device is in a vibration mode; and obtain the screen output content of the terminal device in a case that the environmental noise is greater than a preset noise threshold and that the terminal device is in the vibration mode.

In one embodiment, the information obtaining module 810 is for example configured to: obtain environmental noise and environmental light intensity of an environment where the terminal device is located; and obtain the screen output content of the terminal device in a case that the environmental noise is greater than a preset noise threshold and that the environmental light intensity is less than a preset threshold.

Specific details of the information processing apparatus provided in the embodiments of this disclosure have been described in detail in the corresponding method embodiment, and will not be repeated here.

FIG. 9 schematically shows a structural block diagram of a computer system applicable for implementing an electronic device according to an embodiment of this disclosure.

It is noted that the computer system 900 of the electronic device shown in FIG. 9 is merely an example, and does not constitute any limitation on functions and use ranges of the embodiments of this disclosure.

As shown in FIG. 9, the computer system 900 includes processing circuitry, such as a central processing unit (CPU) 901, which may perform various suitable actions and processing on the basis of computer-readable instructions stored in a read-only memory (ROM) 902 or computer-readable instructions loaded from a storage portion 908 into a random access memory (RAM) 903. The RAM 903 further stores various computer-readable instructions and data required for system operations. The CPU 901, the ROM 902, and the RAM 903 are connected to each other through a bus 904. An input/output (I/O) interface 905 is also connected to the bus 904.

The following components are connected to the I/O interface 905: input parts 906 including a keyboard, a mouse, and the like; output parts 907 including a cathode ray tube (CRT), a liquid crystal display (LCD), a speaker, and the like; a storage part 908 including a hard disk, and the like; and a communication part 909 including a network interface card such as a local area network card, a modem, and the like. The communication part 909 performs communication processing by using a network such as the Internet. A drive 910 is also connected to the I/O interface 905 as required. A removable medium 911, such as a magnetic disk, an optical disc, a magneto-optical disk, or a semiconductor memory, is installed on the drive 910 as required, so that a computer-readable instruction read from the removable medium is installed into the storage part 908 as required.

Particularly, according to the embodiments of this disclosure, the processes described in the various method flowcharts may be implemented as computer-readable instructions. For example, the embodiments of this disclosure include a computer program product, including computer-readable instructions carried on a computer-readable medium (such as a non-transitory computer-readable storage medium), and the computer-readable instructions include program codes used for performing the methods shown in the flowcharts. In such an embodiment, the computer-readable instructions may be downloaded and installed from a network through the communication part 909, and/or installed from the removable medium 911. The computer-readable instructions are executed by the CPU 901 execute the various functions defined in the system of this disclosure.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

This disclosure is intended to cover any variations, uses, or adaptive changes of this disclosure. These variations, uses, or adaptive changes follow the general principles of this disclosure and include common general knowledge or common technical means in the art, which are not disclosed in this disclosure.

It should be understood that this disclosure is not limited to the structures described above and shown in the accompanying drawings, and various modifications and changes can be made without departing from the scope of this disclosure.

The foregoing disclosure includes some exemplary embodiments of this disclosure which are not intended to limit the scope of this disclosure. Other embodiments shall also fall within the scope of this disclosure.

What is claimed is:

1. A method for information processing, comprising:
receiving an output content for a screen display of a terminal device, the output content comprising at least a first character;
converting the output content to one or more vibration codes, the first character in the output content being converted into a first vibration code of the one or more vibration codes;
generating, according to the one or more vibration codes and a set of preset vibration parameters, a device vibration instruction corresponding to the output content; and
controlling, according to the device vibration instruction, the terminal device to generate at least a first vibration with a first vibration frequency and a second vibration with a second vibration frequency that is different from the first vibration frequency.

2. The method according to claim 1, wherein the converting the output content into the one or more vibration codes comprises:
converting the first character in the output content into a Braille character dot matrix; and
converting the Braille character dot matrix into the first vibration code.

3. The method according to claim 2, wherein
the Braille character dot matrix comprises a left dot matrix and a right dot matrix; and
the converting the Braille character dot matrix into the first vibration code comprises:
generating, according to a raise status of each dot in the left dot matrix, a first sub vibration code for the left dot matrix;
generating, according to a raise status of each dot in the right dot matrix, a second sub vibration code for the right dot matrix; and
generating the first vibration code of the first character according to the first sub vibration code for the left dot matrix, a preset interval vibration code, the second sub vibration code for the right dot matrix, and a preset end code.

4. The method according to claim 3, wherein the generating the first sub vibration code comprises:
in response to a first dot in the left dot matrix being a raised dot, generating in the first sub vibration code, a first frequency code corresponding to the first dot, the first frequency code indicating the first vibration frequency; and
in response to the first dot in the left dot matrix being a non-raised dot, generating in the first sub vibration code, a second frequency code corresponding to the first dot, the second frequency code indicating the second vibration frequency.

5. The method according to claim 3, wherein the generating the first sub vibration code comprises:
determining, from a plurality of dot matrix templates, a matching dot matrix template to the left dot matrix, the matching dot matrix template matching raised statuses of dots of the left dot matrix in a preset order; and
setting the first sub vibration code to be a predetermined vibration code associated with the matching dot matrix template.

6. The method according to claim 3, wherein the generating the second sub vibration code comprises:
in response to a first dot in the right dot matrix being a raised dot, generating in the second sub vibration code, a first frequency code corresponding to the first dot, the first frequency code indicating the first vibration frequency; and
in response to the first dot in the left dot matrix being a non-raised dot, generating in the second sub vibration code, a second frequency code corresponding to the first dot, the second frequency code indicating the second vibration frequency.

7. The method according to claim 3, wherein the generating the second sub vibration code comprises:
determining, from a plurality of dot matrix templates, a matching dot matrix template of the right dot matrix, the matching dot matrix template matching raised statuses of dots of the right dot matrix in a preset order; and
setting the second sub vibration code to be a predetermined vibration code associated with the matching dot matrix template.

8. The method according to claim 1, further comprising:
obtaining a code description file; and
parsing the code description file to obtain coding policy information for converting the output content to the one or more vibration codes, the coding policy information comprising a code format and the set of preset vibration parameters, the code format indicating a code structure of the one or more vibration codes, and the set of preset vibration parameters including at least one of the first vibration frequency, the second vibration frequency, or a single vibration duration.

9. The method according to claim 1, further comprising:
obtaining a current coding policy version on the terminal device;
detecting whether the current coding policy version is a specified version;
updating to the specified version when the current coding policy version is not the specified version; and
obtaining coding policy information of the specified version for converting the output content into the one or more vibration codes.

10. The method according to claim 1, wherein the converting the output content to the one or more vibration codes comprises:
performing a word segmentation processing on the output content to obtain at least the first character;
generating, in response to the first character belonging to a library of characters, a simple first vibration code for the first character according to a simple coding policy; and
generating, in response to the first character not belonging to the library of characters, a regular first vibration code for the first character according to a regular coding policy,
wherein a first length of the simple first vibration code generated according to the simple coding policy is shorter than a second length of the regular first vibration code generated according to the regular coding policy.

11. The method according to claim 1, wherein
the set of preset vibration parameters comprises a vibration speed; and
the generating the device vibration instruction comprises:
determining, according to the vibration speed and a vibration duration, an adjusted vibration duration, the vibration duration indicating a duration of each vibration; and
generating the device vibration instruction according to the adjusted vibration duration.

12. The method according to claim 1, further comprising:
determining whether to configure the terminal device in a vibration mode according to an environment noise level of the terminal device.

13. The method according to claim 1, further comprising:
determining whether to configure the terminal device in a vibration mode according to an environmental noise level of the terminal device and an environmental light intensity of the terminal device.

14. An apparatus for information processing, comprising processing circuitry configured to:
receive an output content for a screen display of a terminal device, the output content comprising at least a first character;
convert the output content to one or more vibration codes, the first character in the output content being converted into a first vibration code of the one or more vibration codes;
generate, according to the one or more vibration codes and a set of preset vibration parameters, a device vibration instruction corresponding to the output content; and
control, according to the device vibration instruction, the terminal device to generate at least a first vibration with a first vibration frequency and a second vibration with a second vibration frequency that is different from the first vibration frequency.

15. The apparatus according to claim 14, wherein the processing circuitry is configured to:
convert the first character in the output content into a Braille character dot matrix; and
convert the Braille character dot matrix into the first vibration code.

16. The apparatus according to claim 15, wherein the Braille character dot matrix comprises a left dot matrix and a right dot matrix and the processing circuitry is configured to:
generate, according to a raise status of each dot in the left dot matrix, a first sub vibration code for the left dot matrix;
generate, according to a raise status of each dot in the right dot matrix, a second sub vibration code for the right dot matrix; and
generate the first vibration code of the first character according to the first sub vibration code for the left dot matrix, a preset interval vibration code, the second sub vibration code for the right dot matrix, and a preset end code.

17. The apparatus according to claim 16, wherein the processing circuitry is configured to:
in response to a first dot in the left dot matrix being a raised dot, generate in the first sub vibration code, a first frequency code corresponding to the first dot, the first frequency code indicating the first vibration frequency; and
in response to the first dot in the left dot matrix being a non-raised dot, generate in the first sub vibration code, a second frequency code corresponding to the first dot, the second frequency code indicating the second vibration frequency.

18. The apparatus according to claim 16, wherein the processing circuitry is configured to:
determine, from a plurality of dot matrix templates, a matching dot matrix template of the left dot matrix, the matching dot matrix template matching raised statuses of dots of the left dot matrix in a preset order; and
set the first sub vibration code to be a predetermined vibration code associated with the matching dot matrix template.

19. The apparatus according to claim 14, wherein the processing circuitry is configured to:
obtain a code description file; and
parse the code description file to obtain coding policy information for converting the output content to the one or more vibration codes, the coding policy information comprising a code format and the set of preset vibration parameters, the code format indicating a code structure of the one or more vibration codes, and the set of preset vibration parameters including at least one of the first vibration frequency, the second vibration frequency, and a single vibration duration.

20. A non-transitory computer-readable storage medium storing instructions which when executed by at least one processor in a terminal device cause the at least one processor to perform:
receiving an output content for a screen display of the terminal device, the output content comprising at least a first character;
converting the output content to one or more vibration codes, the first character in the output content being converted into a first vibration code of the one or more vibration codes;
generating, according to the one or more vibration codes and a set of preset vibration parameters, a device vibration instruction corresponding to the output content; and
controlling, according to the device vibration instruction, the terminal device to generate at least a first vibration with a first vibration frequency and a second vibration with a second vibration frequency that is different from the first vibration frequency.
